(19) United States
(12) Patent Application Publication
(10) Pub. No.: US 2013/0118456 A1
(43) Pub. Date: May 16, 2013

(54) OPTIMIZATION OF TANK VENTING OF A FUEL TANK

(71) Applicant: ROBERT BOSCH GMBH, Stuttgart (DE)

(72) Inventors: Andreas Gutscher, Markgroeningen (DE); Andreas Posselt, Muehlacker (DE); Marko Lorenz, Grossbottwar (DE)

(73) Assignee: ROBERT BOSCH GMBH, Stuttgart (DE)

(21) Appl. No.: 13/671,059

(22) Filed: Nov. 7, 2012

(30) Foreign Application Priority Data
Nov. 11, 2011 (DE) 102011086221.8

(51) Int. Cl. B60K 15/035; F02M 33/02

(52) U.S. Cl. CPC B60K 15/035; F02M 33/02
USPC 123/520

(57) ABSTRACT

A system (1) for optimizing tank venting of a fuel tank (3) is presented. The system (1) has a temperature sensor (7), a closed-loop control unit (9) and a tank venting unit (11). The temperature sensor (7) is arranged directly in the fuel tank (3) and is designed to determine a current fuel temperature of a fuel (5) present in the fuel tank (3). The closed-loop control unit (9) is connected to the temperature sensor (7) and to the tank venting unit (11) and is designed to read out the current fuel temperature from the temperature sensor (7). The closed-loop control unit (9) is furthermore designed to control the tank venting unit (11) in accordance with the loading of the activated carbon filter, which in turn depends on the time profile of the fuel temperature.

### BACKGROUND OF THE INVENTION

Exhaust gas reduction and monitoring are important concerns of modern branches of industry. Among the tasks required in the vehicle industry is the interception of fuel vapors from the fuel tank before they reach the environment. This is accomplished, for example, by means of an activated carbon filter (ACF), which can absorb highly volatile hydrocarbons.

The activated carbon filter can be regenerated by being purged with fresh air, thus maintaining its absorption capacity. Regeneration can be accomplished, for example, by sucking fresh air from the environment through the activated carbon filter. For this purpose, there must, for example, be a vacuum in an intake pipe, and a tank venting valve (TVV) must be open. In general, it is only possible to generate a vacuum in the intake pipe when the engine is running, and it is therefore impossible to regenerate the activated carbon filter when the engine is stationary. Given increasingly smaller engines with turbocharging (downsizing), the vacuum in the intake pipe is furthermore no longer adequate to regenerate the activated carbon filter. In the case of hybrid vehicles with an internal combustion engine as a range extender or plug-in hybrids too, the internal combustion engine is inactive for prolonged periods of time, and therefore regeneration of the activated carbon filter is only possible at periodic intervals.

### SUMMARY OF THE INVENTION

There may therefore be a need for an improvement in the tank venting strategy and for a possibility of more effective use of available tank venting phases.

Features, details and possible advantages of a device in accordance with the embodiments of the invention are discussed in detail below.

According to a first aspect of the invention, a system for optimizing tank venting of a fuel tank is presented. The system has a temperature sensor, a closed-loop control unit and a tank venting unit. The temperature sensor is designed to determine a current fuel temperature of a fuel present in the fuel tank. In this case, the temperature sensor is arranged directly in the fuel tank. The closed-loop control unit is connected to the temperature sensor and to the tank venting unit and is designed to read out the current fuel temperature from the temperature sensor. The closed-loop control unit is furthermore designed to control the tank venting unit in accordance with the time profile of the fuel temperature and/or the loading of the activated carbon filter.

The concept of the invention is based on measuring a fuel temperature directly in the fuel tank, e.g. at a filling level measuring unit, and using this measurement to determine the loading of an activated carbon filter with the aid of an outgassing model. A tank venting unit is controlled in accordance with the loading of the activated carbon filter, which depends in turn on the time profile of the fuel temperature.

By determining the fuel temperature directly in the fuel tank, it is possible to obtain accurate measured values that are relevant to the outgassing of the fuel. Thus, the fuel temperature also allows a more accurate knowledge of the loading of the activated carbon filter. With an accurate knowledge of the loading of the activated carbon filter, the tank venting strategy can be optimized. Thanks to the system according to the invention, for example, more rapid control of tank venting and more effective use of the available tank venting phases is possible, e.g. in the case of hybrid vehicles. In particular, it is thereby possible, e.g. in the case of hybrid vehicles, to provide a more accurate definition of a switch-on condition for tank venting and hence to avoid unnecessary phases involving forced operation of the internal combustion engine to vent the tank. It is thereby possible to reduce exhaust gas and CO₂ emissions. Moreover, it is thereby possible to reduce the fuel consumption of a motor vehicle, for example.

An additional advantage arises from the fact that, given an accurate knowledge of the fuel temperature in the fuel tank, it is possible to achieve operating states with a higher pressure, e.g. in a fuel delivery module or in fuel delivery lines. When a particular predeterminable temperature threshold is reached, the pressure can be reduced again. It is thereby possible to provide component protection and to increase the life of the individual elements, such as the fuel delivery module and the fuel delivery lines.

The system can be used, for example, in motor vehicles, especially in hybrid vehicles having an electric motor and an internal combustion engine. The temperature sensor can be integrated into already existing elements in the fuel tank, for example. For example, the temperature sensor can be determined by a filling level measuring unit for the fuel. The closed-loop control unit can be embodied as a controller, in particular as an engine controller, and can be connected to the temperature sensor by a digital interface. As an alternative, the interface can be of analog design. Here, the controller can read out or receive a current temperature of the fuel in the fuel tank from the temperature sensor.

The tank venting unit can have a tank venting valve (TVV), for example, which is designed to open and close a connecting line between an activated carbon filter and an intake pipe or an exhaust gas discharge system. In this case, the tank venting valve must be in an open position to regenerate the activated carbon filter.

According to one embodiment of the invention, the system furthermore has a filling level measuring unit, which is designed to determine a filling level of the fuel in the fuel tank. The filling level measuring unit is connected to the closed-loop control unit by means of a digital interface. The temperature sensor is furthermore integrated into the filling level measuring unit.

The filling level measuring unit can also be referred to as a tank level indicator (TLI) and can have a filling level sensor, for example. The temperature sensor can be embodied as a chip in the filling level measuring unit, for example, the chip determining the current temperature and transmitting it digitally to the closed-loop control unit. Here, the temperature sensor can be embodied integrally with the filling level measuring unit. As an alternative, the temperature sensor can be integrated into other modules that are already present in the fuel tank, e.g. into a pressure sensor. By integrating the temperature sensor into modules that are already present in the fuel tank, it is possible to reduce costs since there is no need for a separate temperature sensor. The digital interface between the module and the closed-loop control unit allows data to be read out from the temperature sensor by the closed-loop control unit and/or integration of the temperature sensor into already existing modules in the fuel tank.

According to another embodiment of the invention, the closed-loop control unit has an outgassing model of the fuel present in the fuel tank. The outgassing model represents a theoretical loading of an activated carbon filter in accordance with the fuel temperature profile and a fuel evaporation property, said filter being connected to the fuel tank. Here, the fuel evaporation property describes the outgassing behavior of the fuel. For example, the fuel evaporation property can depend on the boiling point or boiling profile of the respective fuel. Thus, for example, a fuel evaporation value can contain information as to whether the fuel is one that evaporates easily or is highly volatile.

With the aid of the temperature sensor, the closed-loop control unit determines a current fuel temperature and feeds the latter to the outgassing model. The initial starting point for the fuel evaporation property here is the “worst case fuel”, i.e. a very highly volatile fuel. Using these values and assumptions, the outgassing model determines a current theoretical loading of the activated carbon filter with, for example, hydrocarbons. The loading determined is referred to as theoretical because the outgassing model has only been supplied with a temperature value and not yet with a fuel evaporation value. The current theoretical loading is therefore based on the assumption of a very highly volatile fuel.

The closed-loop control unit is designed to control the tank venting unit in accordance with the current theoretical loading of the activated carbon filter and thereby to optimize tank venting.

According to another embodiment of the invention, the closed-loop control unit is designed to determine a fuel evaporation value and to feed it to the outgassing model. Using the current fuel temperature value and the fuel evaporation value, the outgassing model determines a current actual loading of the activated carbon filter. Through the transmission of the fuel evaporation value to the outgassing model, the outgassing model can be calibrated to the fuel actually present in the fuel tank, and thus the outgassing model is then only dependent on the temperature value. Hence, the current actual loading of the activated carbon filter determined by the outgassing model is more accurate than the current theoretical loading.

The closed-loop control unit is designed to control the tank venting unit in accordance with the current actual loading of the activated carbon filter and thereby to achieve a further improvement in the optimization of tank venting. The accurate knowledge of the loading of the activated carbon filter allows a further reduction in the exhaust gas and CO₂ emissions and an additional lowering of fuel consumption.

The outgassing model can furthermore have a dependence on the ambient pressure and on the tank filling level. These values can be fed to the outgassing model by the closed-loop control unit. The closed-loop control unit can furthermore inform the model of a refueling operation since this may have an effect on the outgassing behavior of the fuel. Moreover, the closed-loop control unit or the outgassing model can take into account a heating capacity of the temperature sensor, in particular of the temperature sensor embodied as a chip.

In addition to being used in the outgassing model to optimize tank venting, the fuel evaporation value determined and the fuel evaporation property which is known therefrom can also advantageously be used for pilot control or closed-loop control of a pressure in the low-pressure fuel supply system when hot starting the engine. In particular, the system pressure in the fuel supply system can be lowered when the fuel evaporation value is known in comparison with pilot control and closed-loop control values based on “worst-case fuel”.

According to another embodiment of the invention, the system furthermore has a lambda sensor, also referred to as a X-probe. The lambda sensor is arranged in the exhaust section of the internal combustion engine and is designed to determine a lambda measured value and transmit it to the closed-loop control unit. The lambda measured value can be representative, for example, of a fuel ratio in a combustion gas. By comparing the current theoretical loading of the activated carbon filter modeled with “worst-case fuel” with a value determined by means of the lambda probe, it is possible to obtain information on the outgassing behavior and on a vapor pressure of the fuel actually used. Here, the closed-loop control unit is designed to determine the fuel evaporation value from the lambda measured value. The fuel evaporation value is fed to the outgassing model as described above.

In addition to optimization of the tank venting strategy, determination or knowledge of the fuel evaporation property enables the following further advantages to be achieved. It may be possible at certain operating points to lower a system pressure maintained in the fuel tank in order to avoid the formation of bubbles in the fuel. Moreover, it is thereby possible to effect a reduction in the electric power of an electric fuel pump (EFP) arranged in the fuel tank. It is furthermore possible, for example, to relieve the load on an onboard electrical system of the motor vehicle.

According to another embodiment of the invention, the tank venting unit has a tank venting valve. The tank venting valve is arranged between the activated carbon filter and an internal combustion engine of the motor vehicle. Here, the closed-loop control unit is designed to open and/or close the tank venting valve in accordance with the determined current fuel temperature. The closed-loop control unit is furthermore designed to open and/or close the tank venting valve in accordance with the current theoretical loading or the current actual loading of the activated carbon filter. In particular, the tank venting valve can be controlled in accordance with the, possibly modeled, activated carbon filter loading, which in turn depends on the time profile of the temperature determined.

According to another embodiment of the invention, the system furthermore has a storage pot, which is arranged in the fuel tank. Here, the temperature sensor is arranged in the storage pot. By arranging the temperature sensor directly in the storage pot, it is possible to ensure that the temperature sensor is immersed in fuel or is in contact with fuel.

According to a second aspect of the invention, a method for optimizing tank venting of a fuel tank is presented. The method has the following steps: determining a current fuel temperature of a fuel present in the fuel tank by means of a temperature sensor, which is arranged directly in the fuel tank; reading out the current fuel temperature from the temperature sensor by means of a closed-loop control unit; controlling a tank venting unit in accordance with activated carbon filter loading, which is in turn dependent on the time profile of the fuel temperature.

Further features and advantages of the present invention will become apparent to a person skilled in the art from the following description of illustrative embodiments with reference to the attached drawings, although said embodiments are not to be interpreted as restricting the invention.

### BRIEF DESCRIPTION OF THE DRAWING

FIG. 1 shows schematically the arrangement of the system for optimizing tank venting in accordance with one embodiment of the invention together with other components of a motor vehicle.

### DETAILED DESCRIPTION

The FIGURE is only a schematic representation of the device according to the invention and of the components thereof in accordance with one embodiment of the invention. Spacings and size relationships, in particular, are not reproduced to scale in the FIGURE.

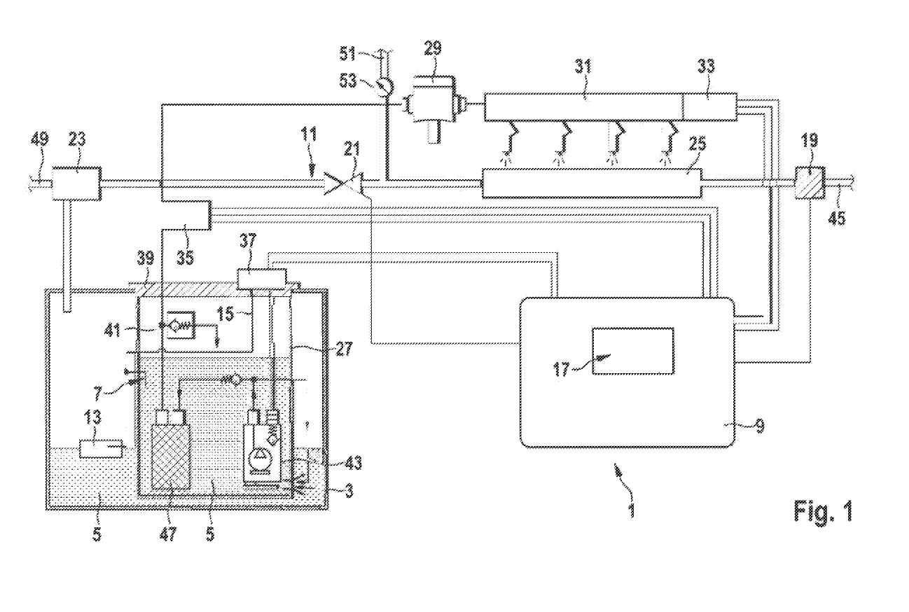

A high assumed loading of an activated carbon filter 23 of a motor vehicle must be reduced by tank venting phases. In the case of hybrid vehicles, tank venting can lead to forced switching on of the internal combustion engine 25. The system 1 illustrated in FIG. 1 optimizes tank venting in such a way that, for example, fewer instances of forced switching on of the internal combustion engine 25 are necessary or the controlled increase in the duty factor of the tank venting valve 21 can be performed more quickly.

The system 1 shown in FIG. 1 provides for the outgassing of the fuel 5 contained in the fuel tank 3 to be modeled. In the process, the system 1 uses a current fuel temperature determined by a temperature sensor 7 directly in the fuel tank 3, in particular in the storage pot 27. In this case, the temperature sensor 7 is integrated into a chip of a filling level measuring unit 13 and is connected to a closed-loop control unit 9 via a digital interface 15. As an alternative, the interface 15 can be of analog design. The closed-loop control unit 9 is embodied as an engine controller and has an outgassing model 17. The outgassing model 17 can be a computer program element and can represent a theoretical loading of the activated carbon filter 23 connected to the fuel tank 3 in accordance with a fuel temperature or with the time profile of a fuel temperature.

After determining the current temperature, the temperature sensor 7 transmits the temperature value to the closed-loop control unit 9. The latter feeds the current fuel temperature value to the outgassing model 17. With the aid of the outgassing model 17, a loading of the activated carbon filter 23 is modeled using the time profile of the fuel temperature value. With an accurate knowledge of the loading of the activated carbon filter 23, the tank venting strategy can be optimized. The closed-loop control unit 9 controls the tank venting unit 11 in accordance with the currently determined activated carbon filter loading. In particular, the tank venting unit 11 contains a tank venting valve 21. Given a knowledge of the state of loading of the activated carbon filter 23, the tank venting valve 21 can be activated precisely at the correct time or with a rapidly increased duty factor by the closed-loop control unit 9, thereby optimizing tank venting.

The above-described determination of the current theoretical state of loading of the activated carbon filter 23 is based first of all on the assumption of a fuel 5 which outgases very easily (“worst-case fuel”). This current theoretical loading is compared with a real outgassing level determined, for example, by means of a lambda sensor 19. In the case of a routine activation of the tank venting valve 21, for example, the lambda sensor 19 determines a fuel evaporation value and transmits the latter to the closed-loop control unit 9. The closed-loop control unit 9 passes this value to the outgassing model 17, which is adapted or calibrated in this way to the fuel 5 actually present in the fuel tank 3. The calibrated outgassing model 17 can then use the current fuel temperature to determine or predict a current actual loading value for the activated carbon filter 23. The closed-loop control unit 9 can then control the tank venting unit 11 even more accurately in accordance with the current actual loading value. The tank venting strategy can thus be further optimized.

During the comparison of the activated carbon filter loading modeled using the “worst-case fuel” with the loading determined by means of the lambda sensor 19, information is obtained on the outgassing behavior of the fuel 5 used. These fuel properties define the minimum system pressure of the fuel 5 necessary to avoid vapor bubbles in the fuel tank 3, e.g. during hot operation or hot starting of the internal combustion engine 25. Normally, the system pressure set is matched to a “worst-case fuel”. Knowledge of the fuel evaporation property or outgassing behavior of the fuel 5 actually present in the fuel tank 3 and offers the possibility of a further reduction in the system pressure.

Knowledge of the current fuel temperature can furthermore be used to protect components, in particular to protect fuel lines and fuel pumps, such as the electric fuel pump. For example, the fuel pressure can be reduced at high temperatures. Lines, connections, fuel filters and fuel pumps are thereby protected. This can be expedient especially when an additional pressure increase ought to be employed in the low pressure system for certain operating states but the setting of this pressure is not permissible when there are relatively high fuel temperatures in the fuel tank 3 so as to protect the plastic. This may be advantageous in the case of a cold start, for example.

FIG. 1 shows the embedding of the system 1 according to the invention in other components of a motor vehicle. The storage pot 27 in which the temperature sensor 7 is arranged is positioned in the fuel tank 3. In addition to further elements, the storage pot 27 has an electric fuel pump 43, a fuel filter 47 and a valve 41. The storage pot 27 is connected to the fuel tank 3 by a tank flange 39. An electronic pump module 37, which is connected to the closed-loop control unit 9, is integrated into the tank flange 39 or integrated in the vicinity of the fuel tank 3.

The fuel tank 3 or the storage pot 27 is connected by a fuel line to a high-pressure pump 29, which feeds the fuel 5 to a high-pressure injection system 31. A fuel low-pressure sensor 35 is arranged on the fuel line. A high-pressure sensor 33 is provided on the high-pressure injection system 31. Both sensors 33, 35 are connected to the closed-loop control unit 9. In this case, the closed-loop control unit 9 is furthermore connected to the tank venting unit 11 or tank venting valve 21, to the temperature sensor 7 and the lambda sensor 19.

A line for discharging the fuel vapors connects the fuel tank 3 to the activated carbon filter 23. In this case, the activated carbon filter 23 is arranged between the fuel tank 3 and the tank venting valve 21 and has a fresh air opening 49. A fresh air intake section 51 with a throttle valve 53 is provided between the tank venting valve 21 and the internal combustion engine 25. The lambda sensor 19 is arranged in the exhaust section 45 of the internal combustion engine 25.

Finally, it is observed that expressions such as “having” or similar are not intended to exclude the possibility of providing further elements or steps. Moreover, it should be noted that “a” or “one” do not exclude the plural. Furthermore, features described in connection with the various embodiments can be combined in any desired manner. It is furthermore observed that the reference signs in the claims should not be interpreted as restricting the scope of the claims.

1. A system (1) for optimizing tank venting of a fuel tank (3), the system (1) comprising:
a temperature sensor (7), which is designed to determine a current fuel temperature of a fuel (5) present in the fuel tank (3);
a closed-loop control unit (9), which is designed to read out the current fuel temperature from the temperature sensor (7) and to determine a time profile of the fuel temperature; and
a tank venting unit (11), wherein the temperature sensor (7) and the tank venting unit (11) are connected to the closed-loop control unit (9);
wherein the temperature sensor (7) is arranged in the fuel tank (3) and the closed-loop control unit (9) is designed to control the tank venting unit (11) in accordance with the time profile of the fuel temperature.

2. The system (1) according to claim 1, further comprising a filling level measuring unit (13), which is designed to determine a filling level of the fuel (5) in the fuel tank (3);
wherein the filling level measuring unit (13) is connected to the closed-loop control unit (9) by a digital or analog interface (15); and
wherein the temperature sensor (7) is integrated into the filling level measuring unit (13).

3. The system (1) according to claim 1, wherein the closed-loop control unit (9) has an outgassing model (17) of the fuel (5) present in the fuel tank (3), which represents a theoretical loading of an activated carbon filter (23) in accordance with the time profile of a fuel temperature, said filter being connected to the fuel tank (3);
wherein the closed-loop control unit (9) is designed to feed the current fuel temperature to the outgassing model (17) and thus to determine a current theoretical loading of the activated carbon filter (23);
wherein the closed-loop control unit (9) is designed to control the tank venting unit (11) in accordance with the current theoretical loading of the activated carbon filter (23).

4. The system (1) according to claim 3, wherein the outgassing model (17) represents the theoretical loading of the activated carbon filter (23) in accordance with the time profile of the fuel temperature and a fuel evaporation property;
wherein the closed-loop control unit (9) is designed to determine a fuel evaporation value;
wherein the closed-loop control unit (9) is designed to feed the fuel evaporation value to the outgassing model (17) and thus determine a current actual loading of the activated carbon filter (23);
wherein the closed-loop control unit (9) is designed to control the tank venting unit (11) in accordance with the current actual loading of the activated carbon filter (23).

5. The system (1) according to claim 4, further comprising a lambda sensor (19), which is arranged between an internal combustion engine (25) and an exhaust gas discharge system (45) and is designed to determine a lambda measured value;
wherein the closed-loop control unit (9) is designed to determine the fuel evaporation value from the lambda measured value in tank venting phases.

6. The system (1) according to claim 1, wherein the tank venting unit (11) has a tank venting valve (21);
wherein the tank venting valve (21) is arranged between an activated carbon filter (23) and an internal combustion engine (25);
wherein the closed-loop control unit (9) is designed to at least one of open and close the tank venting valve (21) in accordance with the determined time profile of the fuel temperature.

7. The system (1) according to claim 1, further comprising a storage pot (27), which is arranged in the fuel tank (3);
wherein the temperature sensor (7) is arranged in the storage pot (27).

8. A method for optimizing tank venting of a fuel tank (3), the method comprising:
determining a current fuel temperature of a fuel (5) present in the fuel tank (3) with a temperature sensor (7), which is arranged in the fuel tank (3);
reading out the current fuel temperature from the temperature sensor (7) with a closed-loop control unit (9);
controlling a tank venting unit (11) in accordance with the time profile of the fuel temperature with the closed-loop control unit (9).

9. The method according to claim 8, further comprising:
feeding the current fuel temperature to an outgassing model (17), which is contained in the closed-loop control unit (9);
determining a current theoretical loading of an activated carbon filter (23) using the current fuel temperature via the outgassing model (17);
controlling a tank venting unit (11) in accordance with the current theoretical loading of the activated carbon filter (23) with the closed-loop control unit (9);
wherein the outgassing model (17) represents the theoretical loading of the activated carbon filter (23) in accordance with a fuel temperature and a fuel evaporation property, said filter being connected to the fuel tank (3).

10. The method according to claim 9, further comprising:
determining the fuel evaporation property by reading out a fuel evaporation value from a lambda probe (19); and
calibrating the outgassing model (17) to the fuel (5) present in the fuel tank (3) by feeding the fuel evaporation value to the outgassing model (17).
